(19) United States
(12) Patent Application Publication
(10) Pub. No.: US 2010/0191945 A1
(43) Pub. Date: Jul. 29, 2010

(54) PORTABLE DEVICE WITH USER INTERFACE

(75) Inventors: Teng Pin Poo, Singapore (SG); Henry Tan, Singapore (SG)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: TREK 2000 INTERNATIONAL LTD., Singapore (SG)

(21) Appl. No.: 12/305,788

(22) PCT Filed: Jul. 13, 2006
(86) PCT No.: PCT/SG2006/000196

§ 371 Date: Dec. 19, 2008

(51) Int. Cl. G06F 9/00; G06F 3/048; G06F 13/12

(52) U.S. Cl. 713/2; 715/771; 710/74

(57) ABSTRACT

A portable device (12) comprising a connector (14) for connecting the portable device (12) to a host (18); a central processing unit (22) for controlling the operation of the portable device (12); at least one non-volatile memory module (24); a user interface (16) for input of user commands to the central processing unit (22) for enabling direct control of at least one function of the portable device (12) in a host (12). The central processing unit (22) is for uploading to a host an auto-run application to reside in the host (18) for enabling the user interface in the host. A corresponding method is also disclosed.

### FIELD OF THE INVENTION

This invention relates to a portable device with a user interface and relates more particularly, though not exclusively, to a portable memory device with a user interface.

### BACKGROUND TO THE INVENTION

When using a portable device with a host such as, for example, a personal computer, laptop computer, notebook computer, personal digital assistant, and so forth, it is normally necessary to use a relatively complex procedure to be able to safely remove the portable device. The portable device is removable from the host and may be, for example, a memory device, a USB flash drive, MP3 player, and so forth. The safely remove procedure will normally involve:
(i) using a mouse to click on a “safely remove hardware” icon in the system tray of the desktop;
(ii) after a graphic user interface (“GUI”) for “safely remove hardware” is displayed, use the mouse to select the device to be removed, and use the mouse to click on “stop”;
(iii) after a GUI for “stop hardware device” is displayed, use the mouse to select the device to be stopped, and again use the mouse to click on “ok”;
(iv) after the display of a message that it is safe to remove the hardware, the device can be removed. Removal of the device causes the display of the message to cease. But the GUI of (iii) remains displayed; and
(v) use the mouse to click on “close” of the GUI of (iii) to cease the display of the GUI. The task is then complete.

This takes five separate steps, with several clicks of the mouse. This is slow, inconvenient, and prone to errors. As a result, some users do not use this procedure. The not using of the procedure may cause the data transfer to be not complete, the file allocation table to be incomplete, the data in the drive might be corrupted, the data copied into the drive might not be there, and the data copied into the drive may be incomplete.

Similar comments can be made about other functions performed by instructions or commands given to the host, for the firmware of the device, and that are effected on the portable device. For example the erasing of files stored on a portable memory device, saving files to a portable memory device, and so forth.

### SUMMARY OF THE INVENTION

According to a first preferred aspect there is provided a portable device comprising:
a connector for connecting the portable device to a host;
a central processing unit for controlling the operation of the portable device;
at least one non-volatile memory module;
a user interface for input of user commands to the central processing unit for enabling direct control of at least one function of the portable device in the host.

According to a second preferred aspect there is provided a method for using a user interface on a portable device for enabling functions within a host to which the portable device is attachable, the method comprising:
detecting the attachment of the portable device to the host;
enumerating the device in the host;
running an auto-run application in the host for enabling direct control of at least one function of the portable device by a user interface of the portable device.

The method may further comprise a preliminary step of determining if the host has the auto-run application and, if not, uploading the auto-run application to the host for residing in the host. Upon the user interface being activated, all necessary functions may be performed automatically and without user involvement and without display of graphic user interfaces.

For both aspects the user interface may be a physical user interface; and may be a push button, a jog button, a rotary wheel, a scroll wheel, and touch button. The at least one function may be safely remove hardware, fast erase of data, slow erase of data, download data, upload data, save data, and the running of a software application. The central processing unit may be for uploading to the host the auto-run application to reside in the host for enabling the user interface in the host. The portable device may be a portable memory device. The portable memory device may be a USB flash memory device.

### BRIEF DESCRIPTION OF THE DRAWINGS

In order that the invention may be fully understood and readily put into practical effect, there shall now be described by way of non-limitative example only a preferred embodiment of the present invention, the description being with reference to the accompanying illustrative drawings.

In the drawings:

FIG. 1 is a front perspective view of a preferred embodiment;

FIG. 2 is a block diagram of the circuitry of the preferred embodiment; and

FIG. 3 is a flow chart of the operation of the preferred embodiment.

### DETAILED DESCRIPTION OF THE PREFERRED EMBODIMENT

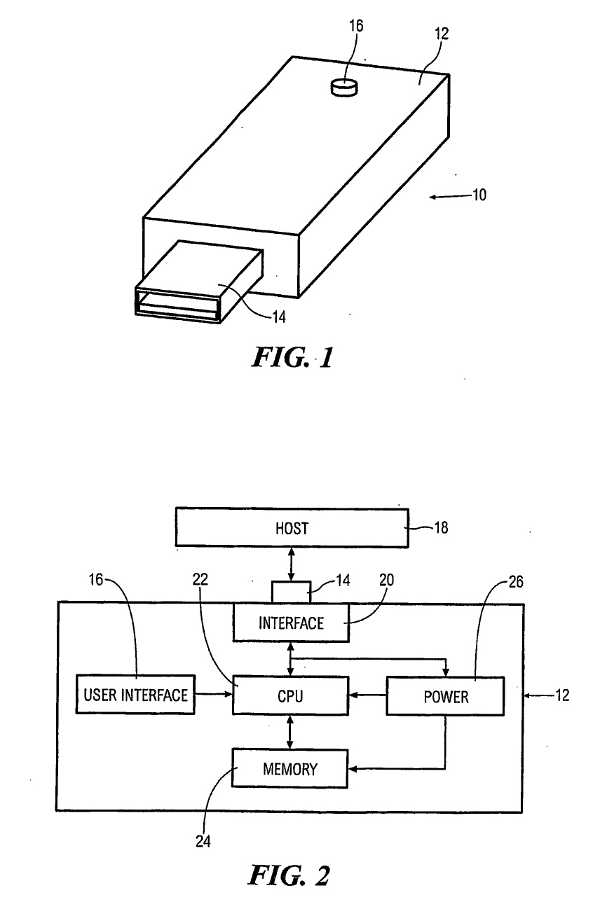

To first refer to FIGS. 1 and 2, there is shown a portable memory device 10 that, in this embodiment, is a USB flash drive. However, it may be any form of portable device including, but not limited to: a memory device, a USB flash drive, and MP3 player, USB hard disk, and USB card reader.

The device 10 has a main body 12 and a connector 14, in this case a USB connector. However, it may be any other suitable form of connector such as, for example, a Firewire connector. Mounted to the body 12 is a physical user interface 16. The user interface 16 may be a push button (as shown) or any other suitable user-activated device including, but not limited to: a jog button, a touch button, a rotary wheel, and a scroll wheel.

The device 10 is adapted to be releasably attached to a host 18 in the normal manner. The device 10 also has a USB interface 20; central processing unit 22 operatively connected to the interface 20; at least one non-volatile memory 24 that may be a single unit or may be several units and that is operatively connected to the central processing unit 20; and a power management module 26 operatively connected to the interface 20, central processing unit 22 and the memory 24. The user interface 16 is operatively connected to the central processing unit 22.

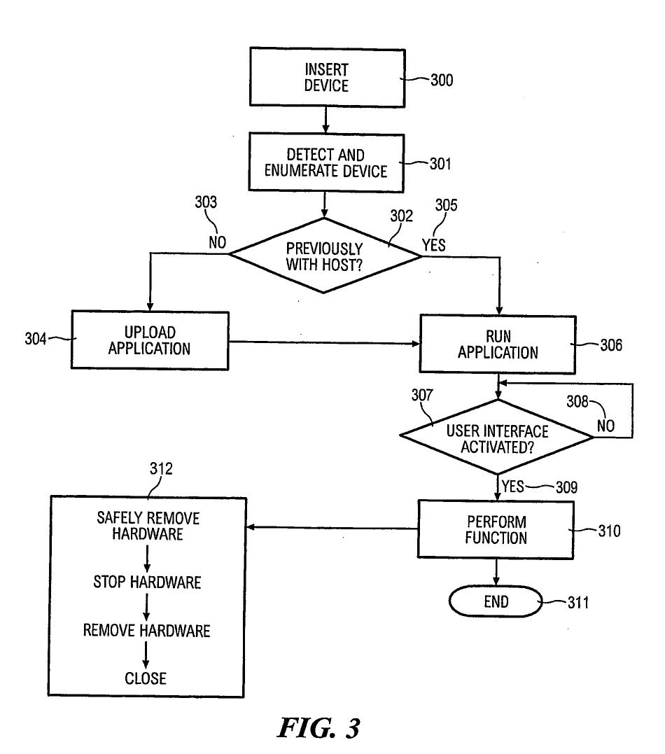

To now refer to FIG. 3, when the device 10 is attached to the host 18 for the first time (300) the device will be detected and enumerated (301) in the normal manner. The device 10 is enabled with “auto-run” functionality. The “auto-run” application will reside in the host 18. Therefore, the first task is to determine if the host 18 has previously used the device 10, or a similar device with the same functionality and ‘auto-run” application (302). If it is the first time for the host 18 (303), the device 10 will run the auto-run application and upload it to the host so it can reside in the host (304). It will continue to reside in the host 18 even after device 10 is no longer operatively connected to the host 18. The auto-run application will automatically run every time the host 18 is switched on. When the upload of (304) is finished, or if the answer at (302) is that the host 18 does have the same auto-run application (305), the process reverts to (306) and the auto-run application is run in the host 18.

The auto-run application will only be invoked if the device 10 is operatively connected to the host and the user interface 16 is operated. So the auto-run application in the host 18 checks to determine of the user interface 16 has been activated (307). If not (308) the process reverts to after (306). Rather than continuous polling for the user interface 16, the auto-run application in the host 18 may wait for an interrupt from the activation of the user interface 16.

When the user interface 16 is activated (309), the host performs the function commanded by the user interface 16. For example, and as shown in box 312 of FIG. 3, if it is to safely remove hardware, the host will automatically activate the safely remove hardware functionality described in sub-paragraph (i) above. As the device is known due to the normal enumeration at detection (301) the safely remove hardware and stop hardware functions in sub-paragraphs (ii) and (iii) will happen automatically. The message of sub-paragraph (iv) will be displayed and, upon the hardware device being removed, the message of sub-paragraph (iv) ceases to be displayed. As there is no display of the GUIs of sub-paragraphs (ii) and (iii), the function of sub-paragraph (v) is not required. When the device is removed or the other functionality has ended, the process ends (311). As can be seen, upon the user interface 16 being activated, all necessary functions are performed automatically and without user involvement and without display of GUIs.

Therefore, once the auto-run application resides in the host 18, it will remain there unless specifically deleted by user action. Whenever a device 10 with user interface 16 is operatively connected to the host 18, the auto-run application will await the activation of the user interface.

Whilst there has been described in the foregoing description a preferred embodiment of the present invention, it will b e understood by those skilled in the technology concerned that many variations or modifications in details of design, construction or operation may be made without departing from the present invention.

1. A portable device comprising:
a connector for connecting the portable device to a host;
a central processing unit for controlling the operation of the portable device;
at least one non-volatile memory module;
a user interface for input of user commands to the central processing unit for enabling direct control of at least one function of the portable device in the host

2. A portable device as claimed in claim 1, wherein the user interface is a physical user interface.

3. A portable device as claimed in claim 1 or claim 2, wherein the user interface is selected from the group consisting of: a push button, a jog button, a touch button, a rotary wheel, and a scroll wheel.

4. A portable device as claimed in any one of claims 1 to 3, wherein the at least one function is selected from the group consisting of: safely remove hardware, fast erase of data, slow erase of data, download data, upload data, save data, and running a software application

5. A portable device as claimed in any one of claims 1 to 4, wherein the central processing unit is for uploading to a host an auto-run application to reside in the host for enabling the user interface in the host.

6. A portable device as claimed in any one of claims 1 to 5, wherein the portable device is a portable memory device.

7. A portable device as claimed in claim 6, wherein the portable memory device is a USB flash memory device.

8. A method for using a user interface on a portable device for enabling functions within a host to which the portable device is attachable, the method comprising:
detecting the attachment of the portable device to the host;
enumerating the device in the host;
running an auto-run application in the host for enabling direct control of at least one function of the portable device by a user interface of the portable device.

9. A method as claimed in claim 8 further comprising a preliminary step of determining if the host has the auto-run application and, if not, uploading the auto-run application to the host for residing in the host.

10. A method as claimed in claim 8 or claim 9, wherein upon the user interface being activated, all necessary functions are performed automatically and without user involvement and without display of graphic user interfaces.

11. A method as claimed in any one of claims 8 to 10, wherein the user interface is a physical user interface.

12. A method as claimed in claim 11, wherein the user interface is selected from the group consisting of: a push button, a jog button, a touch button, a rotary wheel, and a scroll wheel.

13. A method as claimed in any one of claims 8 to 12, wherein the at least one function is selected from the group consisting of: safely remove hardware, fast erase of data, slow erase of data, download data, upload data, save data and running a software application.

14. A method as claimed in any one of claims 8 to 13, wherein a central processing unit is for uploading to the host the auto-run application to reside in the host for enabling the user interface in the host.

15. A method as claimed in any one of claims 8 to 14, wherein the portable device is a portable memory device.

16. A method as claimed in claim 15, wherein the portable memory device is a USB flash memory device.
